(19) United States
(12) Patent Application Publication
(10) Pub. No.: US 2007/0045298 A1
(43) Pub. Date: Mar. 1, 2007

(54) Method of processing organic materials using microwave radiation

(76) Inventors: Vladislav Sklyarevich, Bensalem, PA (US); Mylehaylo Shevelev, Feasterville, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/492,493

(22) Filed: Jul. 25, 2006

Related U.S. Application Data
(60) Provisional application No. 60/708,083, filed on Aug. 12, 2005.

(51) Int. Cl. H05B 6/80

(52) U.S. Cl. 219/687

(57) ABSTRACT

Infant formula in particle form is sterilized by continuously moving a bulk of the homogenized product particles in a cold environment and exposing the particles to concentrated microwave radiation having a frequency between about 20 GHz to about 200 GHz and sufficient power density to heat the particles to their required sterilization temperature in a selected time period to thereby prevent destruction of particle integrity. The thickness of the bulk is selected to be less than the skin layer for the microwave frequency used in the bulk.

### CROSS REFERENCE

This application claims the benefit of U.S. Provisional Application No. 60/708,083, filed Aug. 12, 2005.

### FIELD OF THE INVENTION

This invention relates generally to sterilization of organic powder. More particularly, it relates to an improved method of producing refrigeration-shelf-stable ready-to-feed and concentrated infant formulas and related products, as defined by the U.S. Code of Federal Regulations, which are prepared using pasteurization or ultra-pasteurization processes.

The present invention also can be applied to the sterilization of non-organic powders as well.

### DISCUSSION OF THE PRIOR ART

Infant formula is an example of organic powder that is used as a supplement to or a substitute for breast milk to feed infants. It should be sterilized to remove potential pathogenic organisms that can increase during shelf life. The common way to do this is by heating to a temperature that kills microbes, which is around 135 to 150.degrees. C. (see for example U.S. Pat. Nos. 6,585,900; 6,039,985; 6,093,425; 6,030,650; 5,993,885. However a wide range of reactions take place when infant formulas are heated and such heating influences the safety and quality of the product. If heating takes a long time, some undesirable changes can also take place that can affect the nutritional value and sensory characteristics. In addition, sterilized material can be contaminated on its way from the sterilization site to packaging. Therefore heating should be rapid and followed by fast cooling and the sterilization process should take place as close to packaging as possible.

Different kinds of heating are used. Among them are infrared, hot steam, industrial microwave, ohmic heating, etc. (See for example U.S. Pat. No. 6,039,985). None of them, however, can provide enough power density to accomplish fast heating. The use of these heat sources also creates problems with obtaining fast cooling because the heating process is usually conducted in furnaces, autoclaves, and similar equipment and this massive equipment should also be cooled down. None of these heat sources can provide uniform heating of formula powder useless it is dissolved in water. This makes it difficult to make the sterilization process close to the packing stage.

There is a need for infant formulas and similar products that are not adversely impacted by the disadvantages of sterilization. The final product should include all the required components and meet the updated standards and US regulations regarding “Commercial Sterility” for such kinds of product.

The present invention meets these and other needs, as will become apparent in the description provided hereinafter.

### SUMMARY OF THE INVENTION

According to the present invention, a method of sterilization of organic products, preferably concentrated infant formulas and related products, comprises continuously moving a bulk of homogenized product particles in a cold environment, exposing them to concentrated microwave radiation having a frequency between about 20 GHz to about 200 GHz and sufficient power density to heat the particles to their required sterilization temperature in a selected time, thereby preventing the destruction of particle integrity.

The yield of the process can be increased if the thickness of the bulk is selected to be less than the skin layer for the microwave frequency used in the bulk.

### BRIEF DESCRIPTION OF THE DRAWINGS

FIGS. 1 a, b and c schematically illustrate different ways of moving organic particles through the microwave for the method of the present invention.

### DETAILED DESCRIPTION OF THE INVENTION

The present invention relates generally to sterilization of organic powder. More particularly, it relates to an improved method of producing refrigeration-shelf-stable ready-to-feed and concentrated infant formulas and related products, as defined by the U.S. Code of Federal Regulations, which are prepared using pasteurization or ultra-pasteurization processes.

In the inventive method, a bulk of organic product particles continuously moves and is exposed to concentrated microwave radiation with a frequency between about 20 GHz to about 200 GHz and a sufficient power density. The microwave generators at the chosen frequency are available at power levels of dozens, and even hundreds of kilowatts CW, for example gyrotrons, klystrons, traveling wave tubes, backward wave oscillators and others.

The process parameters are chosen so as to accomplish heating organic particles volumetrically to temperature and in a time sufficient to sterilize the material (kill the microorganisms) but prevent it from destruction.

This allows achieving greater sterilization because it can be accomplished during the final stage of the production cycle.

In the embodiments of the invention discussed above, the thickness of the material particle bulk is selected to be less than the skin layer for the used microwave frequency in the bulk. In this case the coupling of microwave energy by material particles is the highest, and close to 100%. All particles are heated at about the same rate.

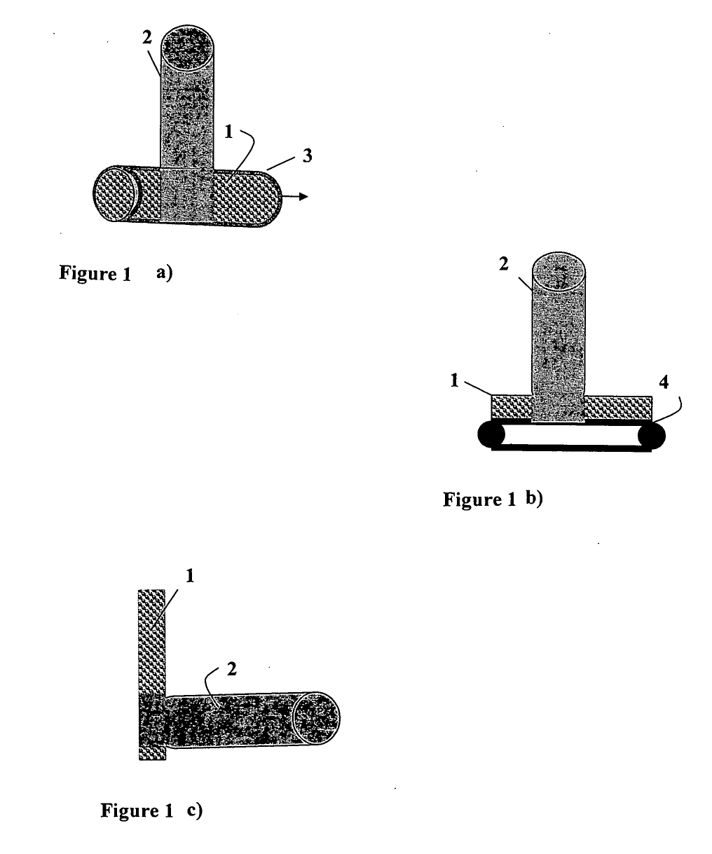

In the embodiment of the invention discussed above, particles 1 (see FIG. 1,a) are moved through the microwave 2 by a cold gas, for example, in a pipe 3 made of transparent-for-microwave material. This material is selected from the group consisting of quartz, Teflon, oxide ceramic, and diamond.

The particles 1 can be moved through the microwave 2 by conveyor 4 (see FIG. 1,b) or they can be projected or dropped (see FIG. 1,c).

The inventive method is generally applicable to the thermal sterilization of any powder materials and for producing refrigeration-shelf-stable ready-to-feed and concentrated complete infant formulas. It increases the quality of the product and brings the sterilization process very close to the packaging site, reducing the opportunity for transit contamination. In fact, the powder can be sterilized as it is on its way to the container. This increases purity of the product. The invention saves energy and production time as well.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A method of sterilization of product in particle form, comprising; continuously moving a bulk of homogenized product particles to be sterilized in a cold environmental, exposing the particles to concentrated microwave radiation having a frequency between about 20 GHz to about 200 GHz and sufficient power density to heat the particles to their required sterilization temperature in a selected time period to thereby prevent destruction of particle integrity.

2. The method of claim 1 wherein the thickness of the bulk is selected to be less than the skin layer for the microwave frequency used in the bulk.

3. The method of claim 1 wherein the product particles are moved by cold gas.

4. The method of claim 3 wherein the product particles are moved in a pipeline made of material that is transparent to the microwave used.

5. The method of claim 4 wherein the pipeline material is selected from the group consisting of quartz, Teflon, oxide ceramic, and diamond.

6. The method of claim 1 wherein the product particles are moved by conveyor.

7. The method of claim 1 wherein the product particles are moved by being projected or dropped.

8. The method of claim 1, wherein said product to be sterilized is organic.

9. The method of claim 8, wherein said organic product is concentrated infant formula.
